(19) United States
(12) Patent Application Publication
(10) Pub. No.: US 2014/0065340 A1
(43) Pub. Date: Mar. 6, 2014

(54) MOISTURIZED ACETYLATED WOOD AND METHODS FOR MAKING THE SAME

(71) Applicant: EASTMAN CHEMICAL COMPANY, Kingsport, TN (US)

(72) Inventors: John Michael Allen, Kingsport, TN (US); James Palmer Dickerson, Kingsport, TN (US)

(73) Assignee: Eastman Chemical Company, Kingsport, TN (US)

(21) Appl. No.: 13/837,015

(22) Filed: Mar. 15, 2013

Related U.S. Application Data
(60) Provisional application No. 61/694,514, filed on Aug. 29, 2012.

(51) Int. Cl. B27K 1/00; B32B 21/13

(52) U.S. Cl. CPC B27K 1/00; B32B 21/13
USPC 428/44; 264/82; 428/535

(57) ABSTRACT

The invention provides flat-packed bundles of wooden boards in which at least some of the internal boards that contain acetylated wood possess certain moisture levels. The invention further provides flat-packed bundles of wooden boards in which at least some of the internal boards that contain acetylated wood have certain degrees of widthwise swelling. Although swelling can occur in several board dimensions, widthwise swelling provides a convenient measure. The invention also provides methods for moisturizing acetylated wood boards prior to assembling them into flat-packed bundles.

### CROSS-REFERENCE TO RELATED APPLICATION

This application claims priority to U.S. Provisional Application No. 61/694,514 filed Aug. 29, 2012, the disclosure of which is incorporated herein by reference in its entirety.

### BACKGROUND OF THE INVENTION

Acetylated wood can be desirable in some applications because of its greater dimensional stability than other wood and because of other qualities. The dimensional stability is due at least in part to the fact that acetylated wood is less susceptible to swelling and shrinking resulting from contact with moisture than wood that has not been acetylated. However, while acetylated wood exhibits greater dimensional stability, it does undergo some dimensional change in response to moisture and there is a continued need for improved acetylated wood processes and products that account for dimensional change.

### SUMMARY OF THE INVENTION

Acetylated wood compositions are provided having improved dimensional stability. Despite its improved dimensional stability, acetylated wood does allow some penetration of moisture and will therefore acquire or release some moisture content when placed in contact with ambient air that contains moisture, and particularly in an outdoor environment. However, in many cases the acetylation reaction and related processes have the effect of removing or reducing levels of water and other moisture in the wood to levels well below equilibrium moisture contents typical under conditions of use of wood products. This is in part because the reactant acetic anhydride used in many acetylation reactions will also react with water in the boards to form acetic acid. In fact, some processes use a step of drying of wood to very low moisture levels prior to acetylation to conserve consumption of the anhydride reactant in the process. Thus, water content is typically very low, if detectable at all, after acetylation. Acetylation does typically result in boards that contain acetic acid moisture, since acetic acid is a reactant in some acetylation process and byproduct of acetylation reactions that use acetic anhydride. However, acetic acid has an odor that some wish to avoid, so some acetylated wood is treated by heating processes to reduce acetic acid content. As a result, wood that has been subjected to acetylation and drying processes can have very low moisture content and much or all of the moisture that is present may be in the form of acetic acid.

Acetylated wood can experience some swelling upon exposure to moisture, so wood with extremely low moisture content will be expected to swell when given the opportunity to uptake moisture while equilibrating in an ambient environment. This equilibration may take some time, however, and although wooden boards undergoing treatment are often arranged in a manner intended to allow large portions of the surfaces of the boards to be in contact with air or other media (for example, by having layers separated by spacers in “stickered” bundles), when treatment is complete, wooden boards are often bundled for shipment purposes using dense bundles (for example, flat-packed bundles) that have much less free space and thus allow much less contact between boards and the outside environment, especially for boards on the interior of the bundle. Such arrangements can result in bundles containing internal boards that have very low moisture content. Such bundles are often opened shortly before use at locations such as a jobsite or processing facility, so that boards may be processed or used prior to equilibrating. Processing and use of boards can include steps such as gluing boards or pieces of boards together, coating boards or pieces of boards, or fixing boards in place with fasteners such as nails, screws, brackets and the like. The occurrence of significant swelling after these steps are completed can lead to problems such as damage to coatings or formation of internal stresses in fastened or glued pieces, possibly leading to cracking or other structural problems.

The invention provides flat-packed bundles of wooden boards in which at least some of the internal boards that contain acetylated wood possess certain moisture levels. The invention further provides flat-packed bundles of wooden boards in which at least some of the internal boards that contain acetylated wood have certain degrees of widthwise swelling. Although swelling can occur in several board dimensions, widthwise swelling provides a convenient measure. The invention also provides methods for moisturizing acetylated wood boards prior to assembling them into flat-packed bundles

The invention thus provides flat-packed bundles of boards containing exterior boards and interior boards, in which at least one interior board contains wood located at least about 18 inches from each end of the board, the wood having a bound acetyl content of at least about 10% by weight, an acetic acid content of no higher than about 2.5% by weight and a moisture content of at least about 3.5% by weight. In some embodiments, the moisture content of the wood is at least about 5% by weight. In some embodiments, the moisture content of the wood is at least about 10% by weight. In some embodiments, the wood has a widthwise swelling factor (X) of at least about 0.20. In some embodiments, the at least one interior board has a mean central widthwise swelling factor (X) of at least about 0.20. In some embodiments, the at least one interior board has a mean central moisture content that is at least about 1.0% by weight above its mean central acetic acid content. In some embodiments, the at least one interior board has a mean central acetic acid content no higher than about 2.5% by weight and a mean central moisture content of at least about 3.5% by weight.

The invention further provides flat-packed bundles of boards containing exterior boards and interior boards, in which at least one interior board includes wood located at least about 18 inches from each end of the board, the wood having a bound acetyl content of at least about 10% by weight and a moisture content that is at least about 1.0% by weight higher than its acetic acid content. In some embodiments, the moisture content of the wood is at least about 5% by weight. In some embodiments, the moisture content of the wood is at least about 10% by weight. In some embodiments, the wood has a widthwise swelling factor (X) of at least about 0.20. In some embodiments, the at least one interior board has a mean central widthwise swelling factor (X) of at least about 0.20. In some embodiments, the at least one interior board has a mean central moisture content that is at least about 5.0% by weight above its mean central acetic acid content. In some embodiments, the at least one interior board has a mean central acetic acid content no higher than about 2.5% by weight and a mean central moisture content of at least about 3.5% by weight. In some embodiments, In some embodiments, the wood has an acetic acid content of no higher than about 2.5% by weight and a moisture content of at least about 3.5% by weight.

The invention further provides flat-packed bundles of boards, wherein the bundles contain exterior boards and interior boards, and wherein at least one interior board contains wood located at least about 18 inches from each end of the board, the wood having a bound acetyl content of at least about 10% by weight and a moisture content that is at least about 1.0% by weight higher than its acetic acid content. In some embodiments, the moisture content of the wood is at least about 5% by weight. In some embodiments, the moisture content of the wood is at least about 10% by weight. In some embodiments, the wood has a widthwise swelling factor (X) of at least about 0.20. In some embodiments, the at least one interior board has a mean central widthwise swelling factor (X) of at least about 0.20. In some embodiments, the at least one interior board has a mean central moisture content that is at least about 5.0% by weight above its mean central acetic acid content. In some embodiments, the at least one interior board has a mean central acetic acid content of no higher than about 2.5% by weight and a mean central moisture content of at least about 3.5% by weight. In some embodiments, the wood has an acetic acid content of no higher than about 2.5% by weight and a moisture content of at least about 3.5% by weight.

The invention further provides flat-packed bundles of boards containing exterior boards and interior boards, in which at least one interior board includes wood having a bound acetyl content of at least about 10% by weight a widthwise swelling factor (X) of at least about 0.20. In some embodiments, the moisture content of the wood is at least about 5% by weight. In some embodiments, the moisture content of the wood is at least about 10% by weight. In some embodiments, the wood has widthwise swelling factor (X) of at least about 0.50. In some embodiments, the at least one interior board has a mean central widthwise swelling factor (X) of at least about 0.20. In some embodiments, the wood has a moisture content that is at least about 1.0% by weight higher than its acetic acid content. In some embodiments, the wood has an acetic acid content of no higher than about 2.5% by weight and a moisture content of at least about 3.5% by weight. In some embodiments, the at least one interior board has a mean central moisture content that is at least about 1.0% by weight higher than its acetic acid content. In some embodiments, the at least one interior board has a mean central acetic acid content no higher than about 2.5% by weight and a mean central moisture content of at least about 3.5% by weight. In some embodiments, the wood is located at least about 24 inches from each end of the board.

The invention further provides flat-packed bundles of boards that include exterior boards and interior boards, in which at least one interior board contains wood having a bound acetyl content of at least about 10% by weight and also having a mean central acetic acid content no higher than about 2.5% by weight as well as a mean central moisture content of at least about 3.5% by weight. In some embodiments, mean central moisture content of the at least one interior board is at least about 5% by weight. In some embodiments, mean central moisture content of the at least one interior board is at least about 10% by weight. In some embodiments, the at least one interior board has a mean central widthwise swelling factor (X) of at least about 0.20.

The invention further provides flat-packed bundles of boards containing exterior boards and interior boards, in which at least one interior board contains wood having a bound acetyl content of at least about 10% by weight and also has a mean central moisture content that is at least about 1.0% by weight above its mean central acetic acid content. In some embodiments, the mean central moisture content of the at least one interior board is at least about 5% by weight. In some embodiments, the mean central moisture content of the at least one interior board is at least about 10% by weight. In some embodiments, the at least one interior board has a mean central widthwise swelling factor (X) of at least about 0.20. In some embodiments, the at least one interior board has a mean central moisture content that is at least about 5.0% by weight above its mean central acetic acid content. In some embodiments, the at least one interior board has a mean central acetic acid content no higher than about 2.5% by weight and a mean central moisture content of at least about 3.5% by weight.

The invention further provides flat-packed bundles of boards, containing exterior boards and interior boards, in which at least one interior board contains wood having a bound acetyl content of at least about 10% by weight and also has a mean central widthwise swelling factor (X) of at least about 0.20. In some embodiments, the mean central moisture content of the at least one internal board is at least about 5% by weight. In some embodiments, the mean central moisture content of the at least one internal board is at least about 10% by weight. In some embodiments, the at least one internal board has a mean central widthwise swelling factor (X) of at least about 0.50. In some embodiments, the at least one internal board has a mean central moisture content that is at least about 1.0% by weight higher than its mean central acetic acid content. In some embodiments, the at least one interior board has a mean central moisture content that is at least about 5.0% by weight higher than its acetic acid content. In some embodiments, the at least one interior board has a mean central acetic acid content no higher than about 2.5% by weight and a mean central moisture content of at least about 3.5% by weight.

In various embodiments of the foregoing flat-packed bundles, the percent bound acetyl content of the wood is: at least about 15% by weight, at least about 16% by weight; at least about 17% by weight; at least about 18% by weight; from about 10% to about 30%; from about 10% to about 25%; from about 15% to about 30%; from about 15% to about 25%; from about 16% to about 30%; from about 16% to about 25%; from about 17% to about 30%; from about 17% to about 25%; from about 18% to about 30%; or from about 18% to about 25%. Embodiments of each of the foregoing flat-packed bundles exist in which the at least one interior board referenced above is a single piece of solid wood. Embodiments of each of the foregoing flat-packed bundles also exist in which at least about 50% of the interior boards in the flat-packed bundle have the characteristics described for the at least one interior board. In some embodiments, at least about 90% of the interior boards in the flat-packed bundle have the characteristics described for the at least one interior board. Embodiments of each of the foregoing flat-packed bundles also exist in which the wood is selected from radiata pine and Southern Yellow Pine. In some embodiments, the wood is Southern Yellow Pine. In some embodiments, at least about 50% of the boards in the bundle contain wood selected from Southern Yellow Pine. In some embodiments, at least about 90% of the boards in the bundle contain wood selected from radiata pine and Southern Yellow Pine. Embodiments of each of the foregoing flat-packed bundles also exist in which at least 95% of the area of at least one cross-section in a height and width plane of the flat-packed bundle is occupied by portions of the wood boards. Embodiments of each of the foregoing flat-packed bundles also exist in which the flat-packed bundle has a span of at least about five boards in at least two dimensions.

The invention further provides methods for making flat-packed bundle of boards, including all of the foregoing flat-packed bundles. In some embodiments, the method includes: moisturizing at least some boards having a bound acetyl content of at least about 10% by weight to produce moisturized boards, then arranging flat packs using wood boards wherein at least some wood boards in the resulting flat pack are the moisturized boards. In some embodiments, the method includes processing wood boards, wherein at least one of the boards contains wood having a bound acetyl content of at least about 10% by weight and a moisture content of less than about 3.5% by weight, the method including, first, moisturizing at least some of the boards having a bound acetyl content of at least about 10% by weight to produce moisturized boards having a bound acetyl content of at least about 10% by weight and a moisture content of at least about 3.5% by weight, and then, arranging flat packs using wood boards wherein at least some wood boards in the resulting flat pack are the moisturized boards. In some embodiments, these methods include exposing at least some of the boards to steam, mist or humidified air while the boards are arrayed in a stickered bundle. In some embodiments, these methods include exposing at least some of the boards to humidified air while the boards are arrayed in a stickered bundle. In some embodiments, these methods include elevating the temperature of the humidified air. In some embodiments, these methods include causing movement of air, mist or steam to promote circulation across the boards.

In some embodiments, the at least some boards have an acetic acid content of no higher than about 2.5% by weight. In some embodiments, the at least some of the moisturized boards contain wood having a moisture content that is at least about 1.0% by weight higher than its acetic acid content. In some embodiments, the at least some of the moisturized boards contain wood having a moisture content of at least about 5.0% by weight. In some embodiments, at least some of the moisturized boards have a mean central widthwise swelling factor (X) of at least about 0.20. In some embodiments, at least some of the wood is selected from radiata pine and Southern Yellow pine. In some embodiments, at least some of the wood is Southern Yellow pine. The resulting flat-packed bundles may be any of the embodiments of bundles described herein.

### DETAILED DESCRIPTION

The invention provides flat-packed bundles of wooden boards in which at least some of the internal boards that contain acetylated wood possess certain moisture levels. The invention further provides flat-packed bundles of wooden boards in which at least some of the internal boards that contain acetylated wood have certain degrees of widthwise swelling. The invention also provides methods for moisturizing acetylated wood boards prior to assembling them into flat-packed bundles.

### Wood boards

Wood boards are boards made from wood. As used throughout this application, a “board” means an elongated member having orthogonal length (l), width (w), and height (h) dimensions, where “l” is the dimension having the longest span and the span of “w” is greater than or equal to that of “h.” In some embodiments, l is at least 3 times greater than w and h. Where “w” and “h” are not equal, “w” is the dimension having the second longest span. In some embodiments, the boards are made from a single piece of wood. Boards have six surfaces: a top, a bottom, two sides and two ends. Length is the distance between the ends, width is the distance between the sides, and height is the distance between the top and bottom. In some embodiments, boards include two or more separate pieces of wood that are physically attached, for example by physical means, chemical means, or both. Some examples of chemical means include adhesives and sealants. Some embodiments involve combinations of boards made from single pieces with boards made from two or more pieces. Some examples of boards that include two or more separate pieces include finger jointed pieces and composite wood products

Woods in wood boards may be a hardwood, softwood or both. In some embodiments the wood is pine, fir, hemlock, spruce, poplar, oak, maple, beech or combinations of two or more of the foregoing (for example, one combination commonly referred to as “Hem-Fir” includes species selected from Western Hemlock, California Red Fir, Grand Fir, Noble Fir, Pacific Silver Fir, and White Fir.) In some embodiments, the wood is red oak, red maple, red alder, hickory, cherry, tulip poplar (yellow poplar), German beech, Pacific albus or combinations of two or more of the foregoing. In some embodiments, the wood includes one or more pine species. In some embodiments, the wood includes Loblolly Pine, Longleaf Pine, Shortleaf Pine, Slash Pine, Radiata Pine, Eastern White Pine, Ponderosa Pine and Scots Pine or combinations of two or more of the foregoing. In some embodiments, the wood includes Radiata Pine. In some embodiments, the wood includes one or more of the four species commercially referred to as “Southern Yellow Pine” (Longleaf Pine, Shortleaf Pine, Slash Pine, Loblolly Pine). In some embodiments, the wood is selected from Longleaf Pine, Shortleaf Pine, and Loblolly Pine. In some embodiments, the wood is Loblolly Pine. Combinations of two or more of any of the foregoing species and groups of species may be used.

In some embodiments, the boards are solid wood. As used throughout this application, “solid wood” shall refer to pieces of wood that measure at least about four feet in at least one dimension but are otherwise of any dimension, e.g. lumber having nominal dimensions such as 2 inches×2 inches by 4 feet, 2 inches×4 inches by 6 feet, 1 inches×1 inches by 6 feet, 2 inches×2 inches by four inches, ×2 inches×2 inches by 6 inches, 1 inch×1 inch by 6 inches, 2 feet×2 feet by 4 feet, 2 feet×2 feet by 6 feet 1 foot×1 foot by 6 feet, one inch by six inches by eight feet, one inch by six inches by twelve feet, one inch by six inches by sixteen feet, two inches by four inches by sixteen feet, two inches by four inches by 12 feet, two inches by four inches by eight feet, etc. Some examples include lumber, boards, planks, squared timber, beams or profiles. Boards of any dimension may be used, provided that at least one dimension is at least about four feet long. The longest dimension (l) can measure, for example, about four feet, about six feet, about eight feet, about ten feet, about twelve feet, about 14 feet, about 16 feet, etc. The longest dimension can also be described as being at least or greater than or equal to any of the foregoing values (e.g. at least about three feet, at least about four feet, greater than or equal to about 12 feet, etc.) or in a range of feet (e.g. from about four to about 20 feet, from about three feet to about 12 feet, from about 10 feet to about 20 feet, etc.) A second dimension (width) of the wood may be the second longest dimension or may be equal the longest dimension (length). Some examples of the second longest dimension include about 1/10 inch, about ⅛ inch, about ⅙ inch, about ¼ inch, about ⅓ inch, about ⅜ inch, about 0.5 inch, about ⅝ inch, about 0.75 inches, about one inch, about 1.5 inches, about two inches, about three inches, about four inches, about five inches, about six inches, about eight inches, about nine inches, about ten inches, about 12 inches, about 14 inches, about 16 inches, about 18 inches, about 20 inches, about 24 inches and about 30 inches. The second longest dimension can also be described as being at least or greater than or equal to any of the foregoing values (e.g. at least about 1/10 inch, greater than or equal to about 0.5 inch, at least about 0.75 inch, etc.). It can also be described as being with a range of values (e.g. from about 1/10 inch to about 20 inches, from about 1/10 inches to about 8 inches, from about ¼ inch to about 6 inches, from about ⅓ inch to about 5 inches, from about 3 to about 5 inches, from about 5 to about 7 inches, from about 1 to about 3 inches, from about ½ to about two inches, etc.) The third dimension (height) can be the same as or different from the second dimension and can be, for example any of the values described above for the second dimension. In some embodiments, the wood measures the same length in all three dimensions. In some embodiments, the solid wood measures at least about four feet in its longest dimension and at least about 0.25 inch in two other dimensions. In some embodiments, the solid wood measures at least about four feet in its longest dimension and at least about 0.5 inch in two other dimensions. In some embodiments, the solid wood measures at least about four feet in its longest dimension and at least about 0.75 inch in two other dimensions. In some embodiments, the solid wood measures at least about eight feet in its longest dimension and at least about 0.5 inch in two other dimensions. In some embodiments, the solid wood measures at least about eight feet in its longest dimension and at least about 0.75 inch in two other dimensions. In some embodiments, the solid wood measures at least about four feet in at least one dimension, at least about 1.5 inches in another dimension and at least about 0.5 inch in a third dimension. In some embodiments, the solid wood measures at least about eight feet in at least one dimension, at least about 1.5 inches in another dimension and at least about 0.5 inch in a third dimension. In some embodiments, the solid wood measures at least about eight feet in its longest dimension, at least about five inches in another dimension and at least about one inch in a third dimension.

The foregoing dimensions can also be expressed as ranges. For example, the longest dimension can also be described as being from about four feet to about 20 feet, from about three feet to about 20 feet, from about 30 inches to about 20 feet, from about four feet to about 18 feet, from about four feet to about 15 feet, from about 30 inches feet to about 15 feet, etc. Some example ranges for the second longest dimension include from about 1/10 inch to about six feet, from about ⅛ inch to about six feet, from about ⅙ inch to about six feet, from about ¼ inch to about six feet, from about ⅓ inch to about six feet, from about ⅜ inch to about six feet, from about 0.5 inch to about six feet, from about 0.5 inch to about four feet, from about 0.5 inch to about two feet, from about 0.5 inch to about 12 inches, from about one inch to about four feet, from about two inches to about four feet, from about four inches to about four feet, from about one foot to about six feet, from about one foot to about four feet, from about one 0.5 inch to about one foot, from about one inch to about two feet, from about one inch to about one foot, from about 0.5 inch to about 18 inches etc. The third dimension can be the same as or different from the second dimension. Some examples ranges for the third longest dimension include each of the ranges described above for the second dimension. Additional examples of ranges for the third dimension include: from about 0.25 inches to about 6 inches, from about 0.25 inches to about 18 inches, from about 0.5 inches to about 18 inches, from about 0.5 inches to about 12 inches, from about 0.75 inches to about 12 inches, and from about 1 inch to about 2 feet. In some embodiments, the solid wood measures from about 30 inches to about 20 feet in its longest dimension about 0.25 inch to about six feet in two other dimensions. In some embodiments, the solid wood measures from about 30 inches to about 20 feet in its longest dimension about 0.5 inch to about six feet in two other dimensions. In some embodiments, the solid wood measures from about four feet to about 18 feet in its longest dimension about 0.5 inch to about 12 inches in two other dimensions. In some embodiments, the solid wood measures from about 36 inches to about 18 feet in its longest dimension and from about 0.5 inches to about six feet in two other dimensions. In some embodiments, the solid wood measures from about four feet to about 18 feet in its longest dimension and from about 0.5 inches to about six feet in two other dimensions. In some embodiments, the solid wood measures from about 30 inches to about 15 feet in its longest dimension and from about 0.75 inches to about 10 inches in two other dimensions. In some embodiments, the solid wood measures from about four feet to about eighteen feet in at least one dimension, from about 1.5 inches to about 10 inches in a second dimension, and from about 0.5 inch to about five inches in a third dimension. In some embodiments, the solid wood measures at from about eight to about 18 feet in its longest dimension, from about five inches to about 15 inches in another dimension and about one inch to about five inches in a third dimension.

By referring to wood that “measures” specific dimensions, it is meant that the stated dimensions are actual measured dimensions and not nominal dimensions. However, these numbers are not limiting and embodiments exist wherein each of the foregoing figures represent nominal dimensions rather than measured dimensions. In some embodiments, one of the dimensions described in the foregoing paragraph is substantially parallel to the direction of the grain of at least some of the solid wood in the board. Thus, any of the measurements above may describe the dimension of the board in the axis of the grain of at least some of the solid wood. In some embodiments, the longest dimension is substantially parallel to the direction of the grain of at least some of the solid wood in the board. Where the profile of the wood is modified at edges (as in the case of wood having a “radius” or rounded edge, for example), all measurements are determined at locations unaffected by such profile modifications.

### Flat-Packed Bundles of Boards

As used throughout this application, a “flat-packed bundle” of wood boards refers to an assembly of wood boards that are adjacently arrayed and stacked such that the top and bottom surfaces of all of the boards are substantially parallel to one another. As used throughout this application, “substantially parallel” shall mean within five degrees of parallel and “substantially perpendicular” shall mean within five degrees of perpendicular. Flat packed bundles have a span of at least three boards in the two dimensions that are substantially perpendicular to the lengthwise direction of the board. In some embodiments, at least some of the boards have aligned ends and sides such that a bundle contains several vertical stacks. In some embodiments, ends, sides or both of some or all of the boards in the bundle can be substantially parallel, but not necessarily aligned with each other such as when single boards are stacked in slightly offset or skewed layers.

Flat packed bundles are packed relatively densely to use space efficiently. Thus, at least about 90% of the area of at least one cross-section in a height and width plane of a flat-packed bundle is occupied by portions of the wood boards. In some embodiments, at least about 92.5% of the area of at least one cross-section in a height and width plane of a flat-pack is occupied by portions of the wood boards. In some embodiments, at least about 95% of the area of at least one cross-section in a height and width plane of a flat-packed bundle is occupied by portions of the wood boards. In some embodiments, at least about 97.5% of the area of at least one cross-section in a height and width plane of a flat-pack is occupied by portions of the wood boards. Cross-sectional areas within a bundle that are not occupied by portions of the wood boards may be occupied by air or other gasses, or any acceptable material. Some examples of materials found in some flat-packed bundle include laths, packaging material such as paper, cardboard, plastic or foam packaging, and the like.

Flat-packed bundles have a span of at least about three boards in at least two dimensions (typically dimensions parallel to the width and height of the board). In some embodiments, flat-packed bundles have a span of at least about five boards in at least two dimensions. In some embodiments, flat-packed bundles have a span of at least about ten boards in at least two dimensions. In some embodiments, flat-packed bundles have a span of at least about fifteen boards in at least two dimensions. In some embodiments, flat-packed bundles have a span of at least about five boards in one dimension and at least about 10 boards in another dimension. In some embodiments, flat-packed bundles have a span of at least about 10 boards in one dimension and at least about 15 boards in another dimension. In some embodiments, flat-packed bundles have a span of from about 5 to about 15 boards in two dimensions. In some embodiments, flat-packed bundles have a span of from about 5 to about 20 boards in two dimensions. In some embodiments, flat-packed bundles have a span of from about 10 to about 50 boards in two dimensions. In some embodiments, flat-packed bundles have a span of from about 5 to about 10 boards in one dimension and about from about 10 to about 20 boards in another dimension. In some embodiments, flat-packed bundles have a span of from about 5 to about 10 boards in one dimension and about from about 30 to about 50 boards in another dimension. In some embodiments, flat-packed bundles have a span of from about 10 to about 30 boards in one dimension and about from about 30 to about 50 boards in another dimension. In some embodiments, flat-packed bundles have a span of from about 5 to about 15 boards in one dimension and from about 10 to about 50 boards in another dimension. In some embodiments, flat-packed bundles have a span of from about 5 to about 15 boards in one dimension and from about 10 to about 20 boards in another dimension.

As such, flat packed bundles have interior boards and exterior boards. “Interior boards” are boards for which most or all of the area of the side, top and bottom surfaces at least partially face other boards in the same flat-packed bundle. Interior boards may have 0, 1 or 2 end surfaces that do not face another board (i.e., that face the exterior of the bundle). Some interior boards may also have one or more ends along with a portion of their length extending outside the bundle, such as in a skewed stacking configuration, but these portions are small (for example, less than about 2% of the total board length, less than about 5% of the total board length or less than about 10% of the total board length). “Exterior boards” are boards in which at least one side, top or bottom surface does not face another board in the same flat-packed bundle. In this context, a surface is “facing” another board if another board is between the surface and the exterior of the bundle, irrespective of whether there is paper, packaging or other material between the boards. Similarly, a surface is “facing” the exterior of the bundle if there are no boards between the surface and the exterior of the bundle, irrespective of whether there is paper, packaging or other material that is not a board between the surface and the exterior of the bundle. As used throughout that application, “internal boards” shall have the same meaning as “interior boards” and “external boards” shall have the same meaning as “exterior boards.”

### Characteristics of Flat-Packed Bundles of the Invention

The flat-packed bundles of the invention include at least one internal board that contains wood having an elevated bound acetyl content. In some embodiments, at least about 25% of the internal boards in the flat-packed bundle have an elevated bound acetyl content. Embodiments also exist in which at least about 40%, at least about 50%, at least about 60%, at least about 75%, at least about 80% or at least about 90% of the internal boards include wood having an elevated bound acetyl content. As used throughout this application, an “elevated” bound acetyl content means a bound acetyl content that exceeds that of natural wood. In some embodiments, the elevated bound acetyl content is at least about 10 weight percent. Embodiments also exist in which the elevated bound acetyl content is at least about 12 weight percent, at least about 13 weight percent, at least about 14 weight percent, at least about 15 weight percent, at least about 16 weight percent, at least about 17 weight percent, at least about 18 weight percent, at least about 19 weight percent, at least about 20 weight percent, at least about 21 weight percent, at least about 22 weight percent, at least about 23 weight percent, at least about 24 weight percent or at least about 25 weight percent. In some embodiments, elevated percent bound acetyl content can be characterized as a range of percentages, such as from about 10 to about 30 weight percent, from about 12 to about 25 weight percent, from about 14 to about 30 weight percent, from about 14 to about 25 weight percent, from about 10 to about 15 weight percent, from about 15 to about 20 weight percent, from about 15 to about 25 weight percent; from about 15 to about 30 weight percent; from about 16 to about 25 weight percent; from about 16 to about 30 weight percent; from about 17 to about 30 weight percent; from about 16 to about 25 weight percent; from about 18 to about 25 weight percent; or from about 17 to about 25 weight percent.

In some embodiments, at least some of the wood in at least one internal board having elevated bound acetyl content also has a specific moisture content. As used throughout this application, “moisture content” refers to the amount of moisture determined by the protocol set forth in this application. The protocol does not measure the content of water alone, but rather the collective amount of materials that vaporize under the test conditions. In some embodiments, at least some of the wood having elevated percent bound acetyl has a moisture content of at least about 3.5 weight percent. Embodiments also exist in which at least some of the wood having elevated percent bound acetyl has a moisture content such as at least about 4.0 weight percent, at least about 4.5 weight percent, at least about 5.0 weight percent, at least about 5.5 weight percent, at least about 6.0 weight percent, at least about 8.0 weight percent, at least about 10.0 weight percent. In some embodiments the moisture level of at least some of the wood having an elevated percent bound acetyl content and located in at least one of the internal boards can be characterized as a range of percentages, such as from about 3.5 to about 15 weight percent, from about 3.5 to about 8 weight percent, from about 3.5 to about 10 weight percent, from about 4.5 to about 10 weight percent, from about 4.5 to about 8 weight percent, from about 4.5 to about 15 weight percent or from about 7.5 to about 15 weight percent.

Embodiments also exist in which the mean central moisture content of at least one internal board having an elevated bound acetyl level and located in the bundle is one of the numbers discussed above. Mean central moisture content for a board is developed by measuring the moisture content using the protocol set forth herein for three test locations that are located outside the end sections of the board, and that have even lengthwise spacing. The arithmetic mean of the three measurements is the mean central moisture content. As used throughout this application “end sections of the board,” means the least 18 inches of length on each end of the board. Where specifically stated, the end section can be longer, for example 20 inches, 22 inches, 24 inches, 28 inches, etc. However, in such embodiments the end sections are specifically identified as such. For example, “20-inch end sections” refers to the last 20 inches of length on each end of the board, “30-inch end section” refers to the last 30 inches,” “36-inch end section” refers to the last 36 inches, and so on. As used throughout this application, “even lengthwise spacing” means that each of the test locations is the same distance from each adjacent test location or end section boundary. Thus, for an 8-foot board with 24-inch end sections, even lengthwise spacing would include one test location at the center of the board length and the two others at three feet from either end. The inch-thick samples are centered on a line having the exact lengthwise distances where possible, but when using the exact location would result in a sample containing visible anomalies (such as knots, spiral grain, compression and tension wood, shakes and pitch pockets), the sample is cut from the nearest wood from the exact location (in the lengthwise direction) that is free from such visible defects but not inside the end section.

In some embodiments, at least some of the moisture content represents components other than acetic acid. Thus, in some embodiments of the bundles in which at least one internal board fits the above descriptions related to bound acetyl and moisture content, at least some of the wood in the at least one internal board having one of the moisture contents described above also has an acetic acid content of about 5.0 weight percent or less. Embodiments also exist in which the acetic acid content of at least some of such wood is about 4.5 weight percent or less, about 4.0 weight percent or less, about 3.5 weight percent or less, about 3.0 weight percent or less, about 2.5 weight percent or less about 2.0 weight percent or less, about 1.5 weight percent or less, or about 1.0 weight percent or less.

Embodiments also exist in which the mean central acetic acid content of at least one internal board that contains wood having an elevated bound acetyl level is within the ranges discussed above. Mean central acetic acid content for a board is developed by measuring the acetic acid content for three test locations that are located outside the end sections of the board, and that have even lengthwise spacing. The arithmetic mean of the three measurements is the mean central acetic acid content. “End sections of the board” (and related definitions such as “24-inch end section”) and “even lengthwise spacing” have the definitions described above.

The invention includes embodiments for each possible combination of the foregoing specified values and ranges for moisture, acetic acid content and percent bound acetyl described above, in which such combination of specified moisture, specified acetic acid and specified percent bound acetyl is found in at least some wood in at least one interior board of a flat-packed bundle. Some examples of such combinations include: a percent bound acetyl content of at least about 10 weight percent, an acetic acid content of no greater than about 2.5 weight percent and a moisture content of at least about 3.5 weight percent; a percent bound acetyl content of at least about 10 weight percent, an acetic acid content of no greater than about 2.5 weight percent and a moisture content of at least about 10.0 weight percent; a percent bound acetyl content of at least about 15 weight percent, an acetic acid content of no greater than about 2.5 weight percent and a moisture content of at least about 5.0 weight percent; a percent bound acetyl content of at least about 17 weight percent, an acetic acid content of no greater than about 2.5 weight percent and a moisture content of at least about 2.5 weight percent; a percent bound acetyl content of at least about 16 weight percent, an acetic acid content of no greater than about 2.5 weight percent and a moisture content of at least about 2.5 weight percent; and so on. These are only examples, and any combination of the above values is within the claimed invention. These combinations may also be expressed as ranges, such as: from about 10 to about 30 percent bound acetyl, about 2.5 weight percent or less of acetic acid, and a moisture level of from about 3.5 to about 15 weight percent; from about 15 to about 25 percent bound acetyl, about 2.5 weight percent or less of acetic acid, and a moisture level of from about 3.5 to about 8 weight percent; from about 17 to about 25 percent bound acetyl, about 2.5 weight percent or less of acetic acid, and a moisture level of from about 3.5 to about 10 weight percent; from about 18 to about 25 percent bound acetyl, about 2.5 weight percent or less of acetic acid, and a moisture level of from about 3.5 to about 10 weight percent; from about 17 to about 30 percent bound acetyl, about 2.5 weight percent or less of acetic acid, and a moisture level of from about 3.5 to about 10 weight percent; from about 18 to about 30 percent bound acetyl, about 2.5 weight percent or less of acetic acid, and a moisture level of from about 3.5 to about 10 weight percent; and so on. Further, the invention includes embodiments for each possible combination of percent bound acetyl ranges, acetic acid content and moisture amounts listed above in which at least about 25% of the internal boards in a flat-packed bundle include wood having such combination of specified elevated percent bound acetyl ranges, specified moisture content and specified acetic acid content. Embodiments for each combination also exist in which the percentage of internal boards in a flat-packed bundle containing wood having the specified combination is at least about 40%, at least about 50%, at least about 60%, at least about 75%, at least about 80% or at least about 90% of the internal boards in a flat-packed bundle.

The invention also includes embodiments for each possible combination of the foregoing specified values of mean central moisture, mean central acetic acid content and percent bound acetyl described above, in which such combination of specified mean central moisture and specified mean central acetic acid content is found in at least one internal board of a flat-packed bundle and the at least one internal board also contains at least some wood having the specified percent bound acetyl. Some examples of such combinations include: wood with a percent bound acetyl content of at least about 10 weight percent on a board with a mean central acetic acid content of no greater than about 2.5 weight percent and a mean central moisture content of at least about 3.5 weight percent; wood having a percent bound acetyl content of at least about 10 weight percent on a board having a mean central acetic acid content of no greater than about 2.5 weight percent and a mean central moisture content of at least about 10.0 weight percent; wood having a percent bound acetyl content of at least about 15 weight percent on a board having a mean central acetic acid content of no greater than about 2.5 weight percent and a mean central moisture content of at least about 5.0 weight percent; a percent bound acetyl content of at least about 18 weight percent on a board having a mean central acetic acid content of no greater than about 2.5 weight percent and a mean central moisture content of at least about 2.5 weight percent; a percent bound acetyl content of at least about 17 weight percent on a board having a mean central acetic acid content of no greater than about 2.5 weight percent and a mean central moisture content of at least about 2.5 weight percent; and so on. These are only examples, and any combination of the above values is within the claimed invention. These combinations may also be expressed as ranges, such as: from about 10 to about 30 percent bound acetyl on a board having a mean central acetic acid content of about 2.5 weight percent or less and a mean central moisture level of from about 3.5 to about 15 weight percent; from about 15 to about 25 percent bound acetyl on a board having a mean central acetic acid content of about 2.5 weight percent or less and a mean central moisture level of from about 3.5 to about 8 weight percent; from about 18 to about 25 percent bound acetyl on a board having a mean central acetic acid content of about 2.5 weight percent or less and a mean central moisture level of from about 3.5 to about 10 weight percent; from about 17 to about 25 percent bound acetyl on a board having a mean central acetic acid content of about 2.5 weight percent or less and a mean central moisture level of from about 3.5 to about 10 weight percent; from about 17 to about 30 percent bound acetyl on a board having a mean central acetic content of about 2.5 weight percent or less of acetic acid, and a moisture level of from about 3.5 to about 10 weight percent; from about 18 to about 30 percent bound acetyl on a board having a mean central acetic content of about 2.5 weight percent or less of acetic acid, and a moisture level of from about 3.5 to about 10 weight percent; and so on. Further, the invention includes embodiments for each such possible combination of percent bound acetyl ranges, mean central moisture and mean central acetic acid content listed above in which at least about 25% percent of the internal boards in the flat-packed bundle have such specified mean central moisture content and specified mean central acetic acid content and include at least some wood having such specified elevated percent bound acetyl ranges. Embodiments for each combination also exist in which the percentage of internal boards in the flat-packed bundle having such specified combination is at least about 40%, at least about 50%, at least about 60%, at least about 75%, at least about 80% or at least about 90% of the internal boards in a flat-packed bundle.

In some embodiments, wood in an internal board that has an elevated bound acetyl level can be described in terms of the difference between the percent acetic acid content and the moisture content. In some embodiments, for example, at least some of the wood having an elevated percent bound acetyl has a moisture content that is at least about 1.0% by weight higher than its acetic acid content. Embodiments also exist in which the moisture content in at least some of the wood in an internal board is at least about 1.5% by weight, at least about 2.0% by weight, at least about 2.5% by weight, at least about 3.0% by weight, at least about 3.5% by weight, at least about 4.0% by weight, at least about 4.5% by weight, at least about 5.0%, at least about 7.5%, at least about 10.0% or at least about 12.5% by weight higher than its acetic acid content. In some embodiments, the amount by which moisture content exceeds acetic acid content can be described as a range, such as from about 1.0% to about 15.0%, from about 2.5% to about 15.0%, from about 1.0% to about 10.0%, from about 2.5% to about 10.0%, from about 1.0% to about 7.5%, from about 2.5% to about 7.5%, from about 1.0% to about 5.0%, from about 1.5% to about 5.0%, from about 2.5% to about 5.0%, from about from about 2.5% to about 7.5%, from about 2.5% to about 12.5%, from about 5.0% to about 12.5%, from about 1.0% to about 12.5%, from about 7.5% to about 10.0%, from about 7.5% to about 12.5% or from about 7.5% to about 15.0%.

Embodiments also exist in which the mean central moisture content of at least one internal board containing wood having an elevated bound acetyl level and located in the bundle is within the ranges discussed above. Mean central moisture content for a board is developed by measuring the acetic acid content for three test locations that are located outside the end sections of the board, and that have even lengthwise spacing. The arithmetic mean of the three measurements is the mean central moisture content. “End sections of the board” (and related definitions such as “24-inch end section”) and “even lengthwise spacing” have the definitions described above.

The invention includes embodiments for each possible combination of the foregoing values and ranges of percent bound acetyl and amount by which percent moisture content exceeds percent acetic acid content described above, in which such combination of specified percent bound acetyl and specified amount by which moisture content exceeds acetic acid content is found in at least some wood in at least one interior board of a flat-packed bundle. Some examples of such combinations include: a percent bound acetyl content of at least about 10 weight percent, and a moisture content that is at least about 1.0 weight percent higher than the acetic acid content; a percent bound acetyl content of at least about 10 weight percent and a moisture content that is at least about 5.0 weight percent higher than the acetic acid content; a percent bound acetyl content of at least about 15 weight percent and a moisture content that is at least about 5.0 weight percent higher than the acetic acid content, and so on. Further, the invention includes embodiments for each possible combination of percent bound acetyl and amount by which moisture content exceeds acetic acid content in which at least about 25% percent of the internal boards in the flat-packed bundle include wood having such combinations of specified percent bound acetyl and specified amount by which moisture content exceeds acetic acid content. Embodiments for each combination also exist in which the percentage of internal boards in the flat-packed bundle containing wood having the specified combination is at least about 40%, at least about 50%, at least about 60%, at least about 75%, at least about 80% or at least about 90% of the internal boards in a flat-packed bundle. Embodiments also exist for each possible combination of the ranges listed above for percent bound acetyl and amount by which the moisture content exceeds the acetic acid content. Some examples include: percent bound acetyl content of from about 10 to about 30 weight percent and a moisture content of from about 1.0% to about 15.0% by weight higher than the acetic acid content; a percent bound acetyl content of from about 15 to about 25 weight percent and a moisture content of from about 1.0% to about 7.5%, by weight higher than the acetic acid content; a percent bound acetyl content of from about 14 to about 25 weight percent and a moisture content of from about 1.0% to about 7.5% by weight higher than the acetic acid content; a percent bound acetyl content of from about 17 to about 25 weight percent and a moisture content of from about 1.0% to about 7.0% by weight higher than the acetic acid content; a percent bound acetyl content of from about 18 to about 25 weight percent and a moisture content of from about 1.0% to about 7.0% by weight higher than the acetic acid content; a percent bound acetyl content of from about 15 to about 25 weight percent and a moisture content of from about 1.0% to about 5.0% by weight higher than the acetic acid content.

The invention also includes embodiments for each possible combination of the foregoing values of percent bound acetyl and amount by which mean central moisture content exceeds mean central acetic acid content described above, in which the amount by which mean central moisture content exceeds mean central acetic acid is found in at least one internal board of a flat-packed bundle and the at least one internal board also contains at least some wood having the specified percent bound acetyl. Some examples of such combinations include: a percent bound acetyl content of at least about 10 weight percent in wood on a board having a mean central moisture content that is at least about 1.0 weight percent higher than its mean central acetic acid content; a percent bound acetyl content of at least about 10 weight percent in wood on a board in which the mean central moisture content is at least about 5.0 weight percent higher the mean central acetic acid content; a percent bound acetyl content of at least about 15 weight percent in wood on a board having a mean central moisture content that is at least about 5.0 weight percent higher than its mean central acetic acid content, and so on. Further, the invention includes embodiments for each such possible combination of percent bound acetyl ranges and amount by which mean central moisture content exceeds mean central acetic acid content, in which at least about 25% percent of the internal boards in the flat-packed bundle have a specified amount by which mean central moisture content exceeds mean central acetic acid content and include at least some wood having such specified elevated percent bound acetyl ranges. Embodiments for each combination also exist in which the percentage of internal boards in the flat-packed bundle having such specified combination is at least about 40%, at least about 50%, at least about 60%, at least about 75%, at least about 80% or at least about 90% of the internal boards in a flat-packed bundle. Embodiments also exist for each possible combination of the ranges listed above for percent bound acetyl and amount by which its mean central moisture content exceeds its mean central acetic acid content. Some examples include: wood with a percent bound acetyl content of from about 10 to about 30 weight percent on a board with a mean central moisture content of from about 1.0% to about 15.0% by weight higher than its mean central acetic acid content; wood with a percent bound acetyl content of from about 15 to about 25 weight percent on a board with a mean central moisture content of from about 1.0% to about 7.5%, by weight higher than its mean central acetic acid content; wood with a percent bound acetyl content of from about 14 to about 25 weight percent on a board with a mean central moisture content of from about 1.0% to about 7.5% by weight higher than its mean central acetic acid content; wood with a percent bound acetyl content of from about 17 to about 25 weight percent on a board with a mean central moisture content of from about 1.0% to about 7.0% by weight higher than its mean central acetic acid content; wood with a percent bound acetyl content of from about 18 to about 25 weight percent on a board with a mean central moisture content of from about 1.0% to about 7.0% by weight higher than its mean central acetic acid content; wood with a percent bound acetyl content of from about 15 to about 25 weight percent on a board with a mean central moisture content of from about 1.0% to about 5.0% by weight higher than its mean central acetic acid content.

The invention also provides embodiments in which specified locations on the boards exhibit a specified degree of swelling that can be described as the portion of the maximum size to which the boards can be swelled. This can be described as the boards' widthwise swelling factor. As used throughout this application, “widthwise swelling factor” (X) shall refer to a measure of the amount of potential widthwise swelling that is exhibited at a selected location on a board, where X=0 indicates that the board has not swelled at all at such location and X=1 indicates that the board has achieved maximum swelling at the specified location on the board. The swelling factor (X) is determined according to the formula: X=(w_{act}−wₘᵢₙ)/(wₘₐₓ−wₘᵢₙ), where w_{act} is that actual measured width at that location as removed from the bundle, wₘᵢₙ is the minimum (dry) width of the board and wₘₐₓ is the maximum (saturated) width at that location. Procedures for preparing samples and for measuring w_{act}, wₘᵢₙ and wₘₐₓ are provided elsewhere in this application. As noted above, where the profile of the wood is modified at edges (as in the case of wood having a “radius” or rounded edge, for example), all measurements are determined at locations unaffected by such profile modifications.

In some embodiments, X measured for a particular location having wood with an elevated acetyl and situated along the length of at least one internal board in a flat-packed bundle and content, is at least about 0.20. Embodiments also exist in which X is at least about 0.25, at least about 0.30, at least about 0.35, at least about 0.40, at least about 0.45, at least about 0.50, at least about 0.60 at least about 0.65, at least about 0.70, at least about 0.80 or at least about 0.90, In some embodiments X is a range. Some examples include from about 0.20 to about 0.95, from about 0.20 to about 0.60, from about 0.25 to about 0.75, from about 0.40 to about 0.80, 0.40 to about 0.95.

The invention further includes embodiments for each possible combination of the foregoing values of percent bound acetyl and widthwise swelling factor (X) described above, in which such combination of specified percent bound acetyl and specified widthwise swelling factor is found in at least some wood in at least one interior board of a flat-packed bundle. Some examples of such combinations include wood having: a percent bound acetyl content of at least about 10 weight percent, and an X value of at least about 0.20; a percent bound acetyl content of at least about 10 weight percent and an X value of at least about 0.50; a percent bound acetyl content of at least about 15 weight percent and an X value of at least about 0.50, and so on. Such combinations can also be expressed as ranges, such as a percent bound acetyl content of from about 10 to about 30 weight percent, and an X value of from about 0.20 to about 0.95; a percent bound acetyl content of from about 10 to about 30 weight percent, and an X value of from about 0.20 to about 0.60; a percent bound acetyl content of from about 10 to about 30 weight percent, and an X value of from about 0.20 to about 0.80; a percent bound acetyl content of from about 10 to about 30 weight percent, and an X value of from about 0.20 to about 0.80; a percent bound acetyl content of from about 15 to about 25 weight percent, and an X value of from about 0.20 to about 0.95; a percent bound acetyl content of from about 15 to about 25 weight percent, and an X value of from about 0.20 to about 0.60; a percent bound acetyl content of from about 15 to about 25 weight percent, and an X value of 15 to about 25; a percent bound acetyl content of from about 15 to about 25 weight percent, and an X value of from about 0.20 to about 0.80; a percent bound acetyl content of from about 17 to about 25 weight percent, and an X value of from about 0.20 to about 0.95; a percent bound acetyl content of from about 18 to about 25 weight percent, and an X value of from about 0.20 to about 0.95; a percent bound acetyl content of from about 17 to about 25 weight percent, and an X value of from about 0.20 to about 0.60; a percent bound acetyl content of from about 18 to about 25 weight percent, and an X value of from about 0.20 to about 0.60; a percent bound acetyl content of from about 17 to about 25 weight percent, and an X value of 17 to about 25; a percent bound acetyl content of from about 18 to about 25 weight percent, and an X value of 17 to about 25; from about 17 to about 25 weight percent, and an X value of from about 0.20 to about 0.80 and from about 18 to about 25 weight percent, and an X value of from about 0.20 to about 0.80. Further, the invention includes embodiments for each possible combination of percent bound acetyl and widthwise swelling factor listed above in which at least about 25% percent of the internal boards in the flat-packed bundle include wood having such combinations of specified percent bound acetyl and specified widthwise swelling factor. Embodiments for each combination also exist in which the percentage of internal boards in the flat-packed bundle containing wood having the specified combination of features is at least about 40%, at least about 50%, at least about 60%, at least about 75%, at least about 80% or at least about 90% of the internal boards in a flat-packed bundle.

Embodiments also exist in which the mean central widthwise swelling factor of at least one board that contains wood having an elevated bound acetyl level and located in the bundle is within one of the X values or ranges discussed above. Embodiments exist for each X value and range listed above. Mean central widthwise swelling factor for a board is developed by measuring the X value for three test locations that are located outside the end sections of the board, and that have even lengthwise spacing. “End sections of the board” (and related definitions such as “24-inch end section”) and “even lengthwise spacing” have the definitions described above.

The invention also includes embodiments for each possible combination of the foregoing values of percent bound acetyl and mean central widthwise swelling factor described above, in which the specified mean central widthwise swelling factor is found in at least one internal board of a flat-packed bundle and the at least one internal board also contains at least some wood having the specified percent bound acetyl. Some examples of such combinations include: a percent bound acetyl content of at least about 10 weight percent in wood on a board having a mean central widthwise swelling factor of at least about 0.20; a percent bound acetyl content of at least about 10 weight percent in wood on a board having a mean central widthwise swelling factor of at least about 0.50; a percent bound acetyl content of at least about 15 weight percent in wood on a board having a mean central widthwise swelling factor of at least about 0.50, and so on. Further, the invention includes embodiments for each such possible combination of percent bound acetyl ranges and mean central widthwise swelling factor, in which at least about 25% percent of the internal boards in the flat-packed bundle have the specified mean central widthwise swelling factor and include at least some wood having the specified elevated percent bound acetyl ranges. Embodiments for each combinations also exist in which the percentage of internal boards in the flat-packed bundle fitting having such specified combination of features is at least about 40%, at least about 50%, at least about 60%, at least about 75%, at least about 80% or at least about 90% of the internal boards in a flat-packed bundle. Such combinations can also be expressed as ranges, such as a percent bound acetyl content of from about 10 to about 30 weight percent, and a mean central widthwise swelling factor of from about 0.20 to about 0.95; a percent bound acetyl content of from about 10 to about 30 weight percent, and a mean central widthwise swelling factor of from about 0.20 to about 0.60; a percent bound acetyl content of from about 10 to about 30 weight percent, and a mean central widthwise swelling factor of from about 0.20 to about 0.80; a percent bound acetyl content of from about 10 to about 30 weight percent, and a mean central widthwise swelling factor of from about 0.20 to about 0.80; a percent bound acetyl content of from about 15 to about 25 weight percent, and a mean central widthwise swelling factor of from about 0.20 to about 0.95; a percent bound acetyl content of from about 15 to about 25 weight percent, and a mean central widthwise swelling factor of from about 0.20 to about 0.60; a percent bound acetyl content of from about 15 to about 25 weight percent, and a mean central widthwise swelling factor of 15 to about 25; a percent bound acetyl content of from about 15 to about 25 weight percent, and a mean central widthwise swelling factor of from about 0.20 to about 0.80; a percent bound acetyl content of from about 17 to about 25 weight percent, and a mean central widthwise swelling factor of from about 0.20 to about 0.95; a percent bound acetyl content of from about 17 to about 25 weight percent, and a mean central widthwise swelling factor of from about 0.20 to about 0.60; a percent bound acetyl content of from about 17 to about 25 weight percent, and a mean central widthwise swelling factor of 17 to about 25; from about 17 to about 25 weight percent, a mean central widthwise swelling factor of from about 0.20 to about 0.80; a percent bound acetyl content of from about 18 to about 25 weight percent, and a mean central widthwise swelling factor of from about 0.20 to about 0.95; a percent bound acetyl content of from about 18 to about 25 weight percent, and a mean central widthwise swelling factor of from about 0.20 to about 0.60; a percent bound acetyl content of from about 18 to about 25 weight percent, and a mean central widthwise swelling factor of 18 to about 25; from about 18 to about 25 weight percent, and a mean central widthwise swelling factor of from about 0.20 to about 0.80.

### Procedures for Determining Various Parameters

Sampling. Procedures are set forth below for determining moisture content, weight percent acetic acid, width-related calculations and weight percent bound acetyls. Where such measurements are to be performed on internal boards in a flat-packed bundle for the purpose of measuring the parameter of the sample as it appears in the bundle, the bundle is disassembled and samples to be tested for moisture and acetic acid content are cut within one hour of disassembling the bundle, and placed immediately within a sealed moisture barrier polyethylene bag that is tied or similarly sealed and maintained at ambient temperature (i.e. not heated or cooled) prior to and after sealing. A cross-sectional (substantially perpendicular to the length dimension and substantially parallel to the height) sample is cut out from the location of the board being tested. The sample is cut to have a thickness of one-inch in the lengthwise dimension of the source board, such thickness being centered on the lengthwise location of the board that is to be tested (except that, as noted above when using the exact location would result in a sample containing visible defects, the sample is cut from the nearest wood from the exact location in the lengthwise direction that is free from such visible defects but not inside an end section). Where required for a testing protocol, a supplemental adjacent sample is cut as a cross-section and taken from a location immediately adjacent to the first sample and having a thickness of one inch. By “immediately adjacent,” it is meant that the supplemental adjacent sample is removed by making a single additional cut because one of the cuts used on the original sample defines one of the borders of the second sample, if such can be accomplished without including visible defects in the immediately adjacent sample. If it cannot, the immediately adjacent sample is cut from the nearest wood from that location in the lengthwise direction that is free from such visible defects but not inside an end section.

Width Measurement, including w_{act, w}ₘᵢₙ and wₘₐₓ. Width measurements for a particular location are taken as follows. As used in this paragraph, references to surfaces (e.g. “top surface,” side surface, etc.) shall refer to the dimensions and surfaces of the board from which the sample was taken, so that “top surface” of the sample will be the sample surface that was part of the top surface of the source board. The width of the board is measured with a 6″ VWR digital caliper with precision to 0.01 mm or an equivalent instrument (including instruments capable of measuring greater lengths as long as they have equivalent precision). First, a line is marked using a pencil and straight edge across the top or bottom surface of the sample. The line runs across what was the width of the source board in a direction that is perpendicular to the side surfaces. The sample is then placed on a flat surface, oriented with the one end down and surface having the drawn line closest to the person making the measurement. Calipers are placed around the side surfaces of the sample until the measuring surface of the caliper is flush against the sample surface that is opposite the surface on which the line was drawn, and the caliper arms are adjusted until the flat surfaces of the caliper arms form a straight line with the drawn line. The dial is adjusted until the caliper arms are tight against the edges of the board (i.e., cannot be tightened without indenting or damaging the board). The width is then read from the digital reading of the caliper device.

Samples are analyzed for w_{act}, wₘᵢₙ and wₘₐₓ measured as follows. First, actual width (w_{act}) of the sample is measured (where a bundle is involved, such measurement must occur within the time period specified above). Next, minimum (dry) width (wₘᵢₙ) is determined as follows: Sample is heated in a well-ventilated convection oven with an internal temperature of 102 to 105° C. for 18 hours, weighed, returned to the oven for another two hours, and removed and weighed again. If the weight at 20 hours (M₂₀) is within 0.1% of the weight at 18 hours (M₁₈), then the sample is considered dry and the dry weight is M₂₀. If M₂₀ is at least 0.1% less than M₁₈, heating for two-hour intervals continues until a mass (Mₓ) is measured that is within 0.1% of the immediately previous measurement (Mₓ₋₂). Wood is considered dry when that occurs, and width wₘᵢₙ is then measured within 5 minutes after Mₓ is determined. After wₘᵢₙ is determined, the sample is “moisture saturated” by being submerged in water under ambient pressure and temperature for 48 hours, then removed from the water for determination of wₘₐₓ. After being removed from the water, the sample is briefly swabbed with a dry towel to removal all free moisture from its surface, and measured within 5 minutes after removal from the water. It will be understood based on the above that when a given sample of wood is to be measured in both “dried” and “moisture saturated” state, the sample is first dried and wₘᵢₙ is measured, then fully saturated and wₘₐₓ is measured.

Moisture Content. Moisture content of a piece of wood, (including a portion of a board in a bundle) is determined as follows. The starting weight of the piece of wood prior to heating (M₀) is measured in grams within the sampling protocol (including time limits) described above. The board is then dried as specified in the above protocol for determining wₘᵢₙ, and the “dried weight” is Mₓ. Moisture content is calculated as follows: (M₀−Mₓ)/M₀.

Percent Bound Acetyl Content. As used throughout this application, both “percent acetic acid content” and “percent bound acetyl” (or “bound acetyl content”) on a portion of a board is determined according to the following procedure. The sample cut having a one-inch thickness in the lengthwise direction of the source board as specified above is drilled completely through by inserting a drill bit at the geometrical center of the sample surface that had been part of the top of the board from which the sample was taken, and drilling in a line through the board such that the tip of the bit travels through the geometrical center of the opposite sample surface (i.e., the surface that had been part of the bottom of the board). Thus, the bit travels through in a direction that is substantially parallel to the surfaces of the sample that were part of the sides of the board from which the sample was taken. The drill uses a ¾″ Forstner bit. Samples of drill shavings are weighed (to the nearest 0.1 mg) to determine the dry sample weight, as follows: An 8 dram vial and cap is placed on a balance, the weight is recorded, and the balance is tared. Into the open vial, with cap on the balance, 0.4900 to 0.5100 g of the sample of the shavings is added and the weight recorded to the nearest 0.0001 g. The vialed sample, without the cap, is then dried in a convection oven set to 105° C. for at least 16 hours. Sample vials are then capped and allowed to cool to room temperature. 20 mL of aqueous 1N (4% (w/v)) sodium hydroxide (Mallinckrodt #7708-10, or equivalent) are pipetted into the vial, and the vial is sealed again and placed in a 50° C. water bath for at least four hours. Contents are mixed both before and after the water bath by shaking for a few seconds, and allowing the wood shavings to settle. 200 microliters of the liquid supernatant is pipetted into a 10 mL flask, 0.1 mL of 85% phosphoric acid (Mallinckrodt #2796, or equivalent) is added, and the liquid is diluted to 10 mL with HPLC grade water (ASTM Type 1 HPLC grade). The resulting solution is mixed thoroughly and, if the solution contains sample particles, filtered to remove the particles.

The acetic acid content of the filtered solution is then determined by reversed phase liquid chromatography using a HYDROBOND PS-C18 column (MAC MOD Analytical Inc., Chadd's Ford, Pa.), or equivalent, the column held at 35 degrees C. using an Agilent Column Compartment, or equivalent, with detection using an Agilent 1100 Series Variable Wavelength Detector (Agilent Technologies, Inc., Santa Clara Calif.) or equivalent at 210 nm. The acetic acid is separated isocratically using pH 2.5 50 millimolar phosphoric acid for seven minutes and the acetic acid (retention time approximately four minutes) is then photometrically detected at 210 nm. The column is flushed with methanol and reequilibrated after every ten samples. A calibration curve is prepared over the range of 10-1000 ppm (corresponding to masses of 0.001-0.10 g of acetic acid in 100 mL calibration solutions). For the sample, the resultant area under the acetic acid peak is compared against the calibration curve to provide the weight of acetic acid in the sample. The determined weight of acetic acid (% Acetic Acid) is then multiplied by a ratio representing the mole weight of the acetyl group divided by the mole weight of acetic acid (that is, 43/60). The product is then divided by the dry weight of the sample in grams (Sample weight, in grams) then multiplied by 100 to express the value as a percent bound acetyl. This can be shown in the following equation: % Bound Acetyl=(weight of Acetic Acid×43/60×100)/Sample weight, in grams.

Acetic Acid Content. As used herein, “acetic acid content” in wood is determined according to the following procedure. The sample cut having a one-inch thickness in the lengthwise direction of the source board as specified above is drilled completely through by inserting a drill bit at the geometrical center of the sample surface that had been part of the top of the board from which the sample was taken, and drilling in a line through the board such that the tip of the bit travels through the geometrical center of the opposite sample surface (i.e., the surface that had been part of the bottom of the board). Thus, the bit travels through in a direction that is substantially parallel to the surfaces of the sample that were part of the sides of the board from which the sample was taken. The drill uses a ¾″ Forstner bit. Samples of drill shavings are weighed (to the nearest 0.1 mg) to determine the sample weight, as follows: An open 8 dram vial is placed on a balance, and the balance is tared. Into the open vial, 0.4900 to 0.5100 g of the sample of the shavings is added and the weight recorded to the nearest 0.0001 g. Using a Class-A pipette, 20 mL of aqueous 0.1N sodium bicarbonate (Mallinckrodt #741212, or equivalent) is added to the vial. Sample vials are then capped and allowed to stand at room temperature for a minimum of four hours. Contents are mixed both before and after the 4 hour waiting period by shaking for a few seconds, and allowing the wood shavings to settle. After the second (post-4 hour) shaking, two mL of the liquid supernatant is pipetted into a 10 mL flask, 0.1 mL of 85% phosphoric acid (Mallinckrodt #2796, or equivalent) is added, and the liquid is diluted to 10 mL with HPLC grade water (ASTM Type 1 HPLC grade). The resulting solution is mixed thoroughly and, if the solution contains sample particles, filtered to remove the particles.

The acetic acid content of the filtered solution is then determined by reversed phase liquid chromatography using a HYDROBOND PS-C18 column (MAC MOD Analytical Inc., Chadd's Ford, Pa.), or equivalent, the column held at 35 degrees C. using an Agilent Column Compartment, or equivalent, with detection using an Agilent 1100 Series Variable Wavelength Detector (Agilent Technologies, Inc., Santa Clara Calif.) or equivalent at 210 nm. The acetic acid is separated isocratically using pH 2.5 50 millimolar phosphoric acid for seven minutes and the acetic acid (retention time approximately four minutes) is then photometrically detected at 210 nm. The column is flushed with methanol and reequilibrated after every ten samples. A calibration curve is prepared over the range of 10-1000 ppm (corresponding to masses of 0.001-0.10 g of acetic acid in 100 mL calibration solutions). For the sample, the resultant area under the acetic acid peak is compared against the calibration curve to provide the amount of acetic acid, in grams, in the sample. This weight is then divided by the weight of the sample in grams (Sample weight, in grams) then multiplied by 100 to express the value as a percent acetic acid. This can be shown in the following equation: % Free Acetic acid=(weight of Acetic Acid in grams×100)/Sample weight.

Multiple Tests Regarding the Same Location on a Board. Width assessment requires an intact section of board and widthwise swelling factor (X) requires width measurement after drying then saturating the board. As noted above, where both X and moisture levels are to be determined on the same section of a board, the board sample used for width determinations is also used to measure Mₓ and M₀ used in determining moisture content. Where both X and percent bound acetyl content are to be determined on the same section of the board, percent bound acetyl content is determined after completion of all of the processing and testing undertaken in connection with X. Where both X and acetic acid content is to be determined on a section of board, a supplemental adjacent sample (as described above) is taken and used to measure acetic acid content while the primary sample is used to determine X. Where percent bound acetyl, acetic acid content and X are to be determined, the percent bound acetyl is performed on the same sample as the X analysis and not on the supplemental adjacent sample. Where percent bound acetyl and acetic acid content are to be determined, but X is not, no supplemental adjacent sample is necessary and the same drill shavings generated for the testing can be divided and used for both tests.

### Methods of Making the Bundles

The invention further provides methods for making the boards and flat-packed bundles of the present invention. The method includes moisturizing at least some boards containing at least some wood having elevated bound acetyl content and a moisture content of less than 3.5% to produce moisturized boards, then arranging the wood boards into flat packs, wherein at least some wood boards in the resulting flat pack are moisturized boards. Boards are thus moisturized while arrayed in a manner that will more readily allow material to contact boards than flat-packed bundles allow, but then subsequently assembled into flat packs.

Moisturizing can be any processing step that increases the moisture content of wood in the boards. In some embodiments, moisture content is increased by a processing step that includes increasing water content. Some examples include applying steam, water vapor or mist to the boards, exposing the boards to ambient air, and placing the boards in an environment with humidity controlled to a selected level. Embodiments involving any of the foregoing processes, or any combination of two or more of such processes, are within the scope of the invention. In some embodiments, steam, mist or humid air are applied by being drawn across one or more surfaces of the boards, through the boards or both.

In some embodiments involving application of steam or mist, steam or mist is applied such that the boards uptake water at a rate of at least about 0.0002 pounds of water per pound of board per hour. Embodiments also exist in which the water uptake rate is at least about 0.0005, at least about 0.0010, at least about 0.0025, at least about 0.0050, at least about 0.0075 or at least about 0.0100 pounds of moisture per pound of board per hour. In some embodiments, the rate is within certain ranges such from about 0.0002 to about 0.0100, from about 0.0010 to about 0.0100 or from about 0.0010 to about 0.0075 pounds of moisture per pound of board per hour.

In some embodiments, penetration of moisture into boards can be enhanced by manipulating pressure, for example by placing boards in a vessel capable of holding vacuum or pressure. In some embodiments, pressure around the boards is increased, for example during the application of humidified vapor, mist or steam. In some embodiments, pressure is reduced, such as through the reduction of pressure to below atmospheric pressure before or during the application of a source of moisture to facilitate migration of some gasses out of the board so that they can be replaced with a moisturizing agent such as water, steam, mist or humidified air. In some embodiments, pressure is first reduced, then the moisturizing agent (e.g. steam, humidified air, mist etc. is introduced to increase pressure in the vessel. Using one or more cycles of alternating pressurization and depressurization can also assist penetration and contact.

In some embodiments involving controlled humidity, boards are moisturized at a relative humidity from about 10 to about 100%. Other ranges of humidities may be used, such as from about 25 to about 90%, from about 25 to about 75%, from about 25 to about 50%, from about 25 to about 100%, from about 50 to about 75%, from about 50 to about 90%, from about 50 to about 100%, and so on. In some embodiments, humidity remains relatively constant during moisturizing, while other embodiments involve humidity that varies during the process. In some embodiments, the humidity is varied by a stepwise or gradual increase in humidity during moisturization. In some embodiments, the relative humidity begins at from about 10% to about 20% and is increased to about 90% or above. In some embodiments, the relative humidity begins at between about 40% and about 50% and is increased to about 90% or above. Such an increase may occur over any acceptable period of time. Some examples include about 1 hour, about 2 hours about 4 hours, about 6 hours, about 8 hours, about 10 hours about 12 hours, about 18 hours, about 24 hours, about 30 hours, about 36 hours, about 48 hours, about 72 hours about 168 hours, etc. In some embodiments, the relative humidity is increased by from about 5 to about 25 percent every four hours. In some embodiments, the relative humidity is increased by from about 1 to about 15 percent every four hours. In some embodiments, the relative humidity is increased by from about 5 to about 15 percent every four hours. In some embodiments, the humidity is varied at an elevated dry bulb temperature from about 90 to about 200° F. In some embodiments, humidity is controlled using heater chambers having adjustable humidity controls.

Any suitable heated chamber may be used. Some examples include kilns, greenhouses, warehouse to special fabricated vessels.

In some embodiments, boards are moisturized simply by exposing them to ambient air for a prolonged period of time prior to arranging them in flat packs. In some embodiments, boards are exposed to air for a period of at least about 2 days. Embodiments exist in which this exposure occurs for at least about 3 days, at least about 5 days, at least about 7 days, at least about 7 days, at least about 12 days, at least about 15 days or at least about 20 days. Embodiments exist in which the duration of exposure can be described as a range, such as from about 2 to about 60 days, from about 2 to about 30 days, from about 3 to about 20 days, from about 5 to about 30 days, from about 5 to about 15 days, from about 7 to about 20 days, from about 7 to about 15 days, from about 12 to about 20 days or from about 12 to about 30 days. In some embodiments, movement of air, mist or steam is used to promote circulation of air across boards. In some embodiments, the air is heated to assist in diffusion in and out of the boards.

In some embodiments, one or more of the foregoing treatments are applied at an elevated (i.e. above ambient) temperature to accelerate penetration of moisture into the boards. In some embodiments, the elevated temperature selected is below that at which moisture will evaporate or boil at an undesired rate. In some embodiments, the temperature is from about 70 degrees F. to about 200 degrees F. Other ranges of temperatures may be used, such as from about 70° F. to about 180° F., from about 70° F. to about 90° F. about 100° F. to about 200° F., about 100° F. to about 180° F., about 100° F. to about 160° F., about 120° F. to about 200° F., about 120° F. to about 180° F., about 120° F. to about 160° F. and so on. In some embodiments, temperature may be “ramped up” during the early stages of heating, especially if the humidification process is taking place in a chamber that has not been heated prior to insertion of the boards. The foregoing temperatures refer to temperatures measured in the air or gases surrounding the boards rather than within the boards themselves.

The moisturizing step may be applied to boards in any form or configuration that provides the appropriate amount of contact between the boards and the moisturizing medium. In some embodiments, the moisturizing step is applied to boards that are arranged in a stickered bundle, such as a stickered bundle that has been treated in an acetylation process, a drying process or both. Stickered bundles are vertically stacked boards with stickers (spacers) between layers of boards. Stickers are typically small elongated objects such as rods or boards, made of material having a selected thickness. Stickers may be of any effective thickness or combination thereof. Layers of stickers are interposed between layers of boards, but the layer of stickers includes extensive open spaces. Any known or effective thickness or material of composition for stickers may be used. Stickers may have any acceptable cross-section configurations. Some examples include square, rectangular, triangular, etc. Some example thicknesses of stickers include about ¼ inch, about ⅓ inch, about ⅜ inch, about 0.5 inch, about ⅝ inch, about 0.75 inch, about one inch, about 1.5 inches, about two inches. In some embodiments, a layer of stickers is interposed between each layer of boards in a stack. In some embodiments, the stickers are arrayed such that a stack of wood is between each sticker, each stack has a thickness of about 0.5 inches and each stack contains multiple pieces of solid wood having dimensions less than about 0.5 inches are stacked between them. Embodiments exist in which the thickness of the stacks of wood between stickers is about 0.75 inches, about one inch, about 1.5 inches, about two inches, about three inches, about four inches, about five inches, about six inches, about eight inches, about nine inches, about ten inches, about 12 inches, about 14 inches, about 16 inches, about 8 inches, about 20 inches, about 24 inches, about three feet about four feet, etc. The thicknesses of the wood in the foregoing sentence can reflect single pieces of wood of such thickness or stacks of wood of such thickness, for example, a single piece of wood about four inches thick or a stack of four pieces of wood that are each about one inch thick. The thicknesses of the stacks of wood can also be described as being at least or greater than or equal to any of the foregoing values (e.g. at least about 0.75 inch greater than or equal to about 1.5 inches, etc.).

This invention can be further illustrated by the following examples of embodiments thereof, although it will be understood that these examples are included merely for purposes of illustration and are not intended to limit the scope of the invention unless otherwise specifically indicated.

### EXAMPLES

Southern yellow pine boards having 16 foot length by 5.5 inch width by one inch height are acetylated then heated such that at least some of the boards contain wood having a bound acetyl content greater than 10% and a moisture content less than 2.5%. The boards are arranged in a stickered bundle containing 40 layers of eight boards each, side by side on each layer, with each layer separated by seven, ½ inch×1 inch×4 feet sticks, placed evenly along the length of the boards. The boards are placed in a Koetter TimberTike kiln, which has both temperature and humidity controls. The initial kiln dry bulb temperature is ramped up to 140° F. over 6 hours at a relative humidity of 25-35%. The temperature is then held at 140-150° F., with relative humidity gradually increasing at a rate of 3% every 10 hours up to a final value 83% after 180 hours. At this time, the stickered bundle is removed, and boards from the stickered bundle are assembled into flat-packed bundles 40 layers high having eight boards per layer (bundle dimensions of approximately four feet by 3 feet by 16 feet).

The embodiments of the invention described above are to be used as illustration only, and should not be used in a limiting sense to interpret the scope of the present invention. Obvious modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. A flat-packed bundle of boards, wherein the bundle comprises exterior boards and interior boards, and wherein at least one interior board comprises wood located at least about 18 inches from each end of the board, the wood having a bound acetyl content of at least about 10% by weight, an acetic acid content of no higher than about 2.5% by weight and a moisture content of at least about 3.5% by weight.

2. The flat-packed bundle of boards of claim 1, wherein the moisture content of the wood is at least about 5% by weight.

3. The flat-packed bundle of boards of claim 1, wherein the moisture content of the wood is at least about 10% by weight.

4. The flat-packed bundle of boards of any of claim 1, wherein the wood has a widthwise swelling factor (X) of at least about 0.20.

5. The flat-packed bundle of boards of claim 1, wherein the at least one interior board has a mean central widthwise swelling factor (X) of at least about 0.20.

6. The flat-packed bundle of boards of claim 1, wherein the at least one interior board has a mean central moisture content that is at least about 1.0% by weight above its mean central acetic acid content.

7. The flat-packed bundle of boards of claim 1, wherein the at least one interior board has a mean central acetic acid content no higher than about 2.5% by weight and a mean central moisture content of at least about 3.5% by weight.

8. The flat-packed bundle of boards of claim 1, wherein the at least one interior board comprises at least about 50% of the interior boards in the flat-packed bundle.

9. The flat-packed bundle of boards claim 1, wherein the at least one interior board comprises at least about 90% of the interior boards in the flat-packed bundle.

10. The flat-packed bundle of boards of claim 1, wherein the wood is selected from radiata pine and Southern Yellow Pine.

11. The flat-packed bundle of boards of claim 1, wherein the wood is Southern Yellow Pine.

12. The flat-packed bundle of boards of claim 1, wherein the percent bound acetyl content of the wood is at least about 15% by weight.

13. The flat-packed bundle of boards of claim 1, wherein the percent bound acetyl content of the wood is at least about 16 weight percent.

14. The flat-packed bundle of boards of claim 1, wherein the percent bound acetyl content of the wood is at least about 18 weight percent.

15. The flat-packed bundle of boards of claim 1, wherein the percent bound acetyl content of the wood is at least about 20 weight percent.

16. The flat-packed bundle of boards of claim 1, wherein the at least one interior board is a single piece of solid wood.

17. The flat-packed bundle of boards of claim 1, wherein at least 95% of the area of at least one cross-section in a height and width plane of the flat-packed bundle is occupied by portions of the wood boards.

18. The flat-packed bundle of boards of claim 1, wherein the flat-packed bundle has a span of at least about five boards in at least two dimensions.

19. A method for making the flat-packed bundle of boards of claim 1, the method comprising:
a. moisturizing at least some boards having a bound acetyl content of at least about 10% by weight to produce moisturized boards; and
b. arranging flat packs using wood boards wherein at least some wood boards in the resulting flat pack are the moisturized boards.

20. A flat-packed bundle of boards, wherein the bundle comprises exterior boards and interior boards, and wherein at least one interior board comprises wood located at least about 18 inches from each end of the board, the wood having a bound acetyl content of at least about 10% by weight and a moisture content that is at least about 1.0% by weight higher than its acetic acid content.

21. The flat-packed bundle of boards of claim 20, wherein the moisture content of the wood is at least about 5% by weight.

22. The flat-packed bundle of boards of claim 20, wherein the moisture content of the wood is at least about 10% by weight.

23. The flat-packed bundle of boards of claim 20, wherein the wood has a widthwise swelling factor (X) of at least about 0.20.

24. The flat-packed bundle of boards of claim 20, wherein the at least one interior board has a mean central widthwise swelling factor (X) of at least about 0.20.

25. The flat-packed bundle of boards of claim 20, wherein the at least one interior board has a mean central moisture content that is at least about 5.0% by weight above its mean central acetic acid content.

26. The flat-packed bundle of boards of claim 20, wherein the at least one interior board has a mean central acetic acid content no higher than about 2.5% by weight and a mean central moisture content of at least about 3.5% by weight.

27. The flat-packed bundle of boards of claim 20, wherein the wood has an acetic acid content of no higher than about 2.5% by weight and a moisture content of at least about 3.5% by weight.

28. The flat-packed bundle of boards of claim 20, wherein the at least one interior board comprises at least about 50% of the interior boards in the flat-packed bundle.

29. The flat-packed bundle of boards claim 20, wherein the at least one interior board comprises at least about 90% of the interior boards in the flat-packed bundle.

30. The flat-packed bundle of boards of claim 20, wherein the wood is selected from radiata pine and Southern Yellow Pine.

31. The flat-packed bundle of boards of claim 20, wherein the wood is Southern Yellow Pine.

32. The flat-packed bundle of boards of claim 20, wherein the percent bound acetyl content of the wood is at least about 15% by weight.

33. The flat-packed bundle of boards of claim 20, wherein the percent bound acetyl content of the wood is at least about 16 weight percent.

34. The flat-packed bundle of boards of claim 20, wherein the percent bound acetyl content of the wood is at least about 18 weight percent.

35. The flat-packed bundle of boards of claim 20, wherein the percent bound acetyl content of the wood is at least about 20 weight percent.

36. The flat-packed bundle of boards of claim 20, wherein the at least one interior board is a single piece of solid wood.

37. The flat-packed bundle of boards of claim 20, wherein at least 95% of the area of at least one cross-section in a height and width plane of the flat-packed bundle is occupied by portions of the wood boards.

38. The flat-packed bundle of boards of claim 20, wherein the flat-packed bundle has a span of at least about five boards in at least two dimensions.

39. A method for making the flat-packed bundle of boards of any of claim 20, the method comprising:
c. moisturizing at least some boards having a bound acetyl content of at least about 10% by weight to produce moisturized boards; and
d. arranging flat packs using wood boards wherein at least some wood boards in the resulting flat pack are the moisturized boards.

40. A method for processing wood boards, wherein at least one of the boards comprises wood having a bound acetyl content of at least about 10% by weight and a moisture content of less than about 3.5% by weight, comprising:
a. moisturizing at least some of the boards having a bound acetyl content of at least about 10% by weight to produce moisturized boards having a bound acetyl content of at least about 10% by weight and a moisture content of at least about 3.5% by weight; and
b. arranging flat packs using wood boards wherein at least some wood boards in the resulting flat pack are the moisturized boards.

41. The method of claim 40, wherein moisturizing comprises exposing at least some of the boards to steam, mist or humidified air while the boards are arrayed in a stickered bundle.

42. The method of claim any of claim 40, wherein moisturizing comprises exposing at least some of the boards to humidified air while the boards are arrayed in a stickered bundle.

43. The method of claim 42, wherein moisturizing comprises elevating the temperature of the humidified air.

44. The method of claim 40, wherein the method comprises causing movement of air, mist or steam to promote circulation across the boards.

45. The method of claim 40, wherein the at least some boards have an acetic acid content of no higher than about 2.5% by weight.

46. The method of claim 40, wherein the at least some of the moisturized boards contain wood having a moisture content that is at least about 1.0% by weight higher than its acetic acid content.

47. The method of claim 40, wherein the at least some of the moisturized boards contain wood having a moisture content of at least about 5.0% by weight.

48. The method of claim 40, wherein at least some of the moisturized boards have a mean central widthwise swelling factor (X) of at least about 0.20.

49. The method of claim 40, wherein at least some of the wood is selected from radiata pine and Southern Yellow pine.

50. The method of claim 40, wherein at least some of the wood is Southern Yellow pine.
